(19) United States
(12) Patent Application Publication
(10) Pub. No.: US 2025/0048220 A1
(43) Pub. Date: Feb. 6, 2025

(54) TRIGGERING AN ACTION IN RESPONSE TO AN EVENT NOTIFICATION CORRESPONDING TO A USER EQUIPMENT

(71) Applicant: Lenovo (Singapore) Pte. Ltd., New Tech Park (SG)

(72) Inventor: Emmanouil Pateromichelakis, Viersen (DE)

(21) Appl. No.: 18/697,174

(22) PCT Filed: Nov. 11, 2021
(86) PCT No.: PCT/EP2021/081434

§ 371 Date: Mar. 29, 2024

(30) Foreign Application Priority Data
Sep. 30, 2021 (GR) 20210100649

(51) Int. Cl. H04W 36/32; H04W 4/12

(52) U.S. Cl. CPC H04W 36/32; H04W 4/12

(57) ABSTRACT

Apparatuses, methods, and systems are disclosed for triggering an action in response to an event notification corresponding to a user equipment. One method includes receiving, from a detection entity, an event notification related to an adaption of a behavior of at least one user equipment. The method includes determining, in response of receiving the event notification, a trigger action for at least one application of the at least one user equipment. The trigger action includes: an edge support service modification; an edge support service cancellation; an edge support service pause; selection of an alternative application server; creation of a new candidate target application server; or some combination thereof. The method includes transmitting the trigger action to an application entity, a further application enablement entity, or a combination thereof to execute the trigger action based on the event notification.

### FIELD

The subject matter disclosed herein relates generally to wireless communications and more particularly relates to triggering an action in response to an event notification corresponding to a user equipment.

### BACKGROUND

In certain wireless communications networks, a planned UE behavior may change after the launch of an edge support service. In such networks, the edge support service may not perform required functions accurately.

### BRIEF SUMMARY

Methods for triggering an action in response to an event notification corresponding to a user equipment are disclosed. Apparatuses and systems also perform the functions of the methods. One embodiment of a method includes receiving, at a network entity and from a detection entity, an event notification related to an adaption of a behavior of at least one user equipment. In some embodiments, the method includes determining, in response of receiving the event notification, a trigger action for at least one application of the at least one user equipment. The trigger action includes: an edge support service modification; an edge support service cancellation; an edge support service pause; selection of an alternative application server; creation of a new candidate target application server; or some combination thereof. In certain embodiments, the method includes transmitting the trigger action to an application entity, a further application enablement entity, or a combination thereof to execute the trigger action based on the event notification.

One apparatus for triggering an action in response to an event notification corresponding to a user equipment includes a network entity. In some embodiments, the apparatus includes a receiver that receives, from a detection entity, an event notification related to an adaption of a behavior of at least one user equipment. In various embodiments, the apparatus includes a processor that determines, in response of receiving the event notification, a trigger action for at least one application of the at least one user equipment. The trigger action includes: an edge support service modification; an edge support service cancellation; an edge support service pause; selection of an alternative application server; creation of a new candidate target application server; or some combination thereof. In certain embodiments, the apparatus includes a transmitter that transmits the trigger action to an application entity, a further application enablement entity, or a combination thereof to execute the trigger action based on the event notification.

Another embodiment of a method for triggering an action in response to an event notification corresponding to a user equipment includes receiving, at a first network entity, a monitoring event from an application, a second network entity, or a combination thereof. In some embodiments, the method includes determining, in response of receiving the monitoring event, an event notification related to an adaption of a behavior of at least one user equipment. In certain embodiments, the method includes transmitting the event notification to a further application enablement entity.

Another apparatus for triggering an action in response to an event notification corresponding to a user equipment includes a first network entity. In some embodiments, the apparatus includes a receiver that receives a monitoring event from an application, a second network entity, or a combination thereof. In various embodiments, the apparatus includes a processor that determines, in response of receiving the monitoring event, an event notification related to an adaption of a behavior of at least one user equipment. In certain embodiments, the apparatus includes a transmitter that transmits the event notification to a further application enablement entity.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for triggering an action in response to an event notification corresponding to a user equipment;

FIG. 2 is a schematic block diagram illustrating one embodiment of an apparatus that may be used for triggering an action in response to an event notification corresponding to a user equipment;

FIG. 3 is a schematic block diagram illustrating one embodiment of an apparatus that may be used for triggering an action in response to an event notification corresponding to a user equipment;

FIG. 4 is a schematic block diagram illustrating one embodiment of a system for triggering an action in response to an event notification corresponding to a user equipment;

FIG. 5 is a timing diagram illustrating a first embodiment of a system for triggering an action in response to an event notification corresponding to a user equipment;

FIG. 6 is a timing diagram illustrating a second embodiment of a system for triggering an action in response to an event notification corresponding to a user equipment;

FIG. 7 is a flow chart diagram illustrating one embodiment of a method for triggering an action in response to an event notification corresponding to a user equipment; and

FIG. 8 is a flow chart diagram illustrating another embodiment of a method for triggering an action in response to an event notification corresponding to a user equipment.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

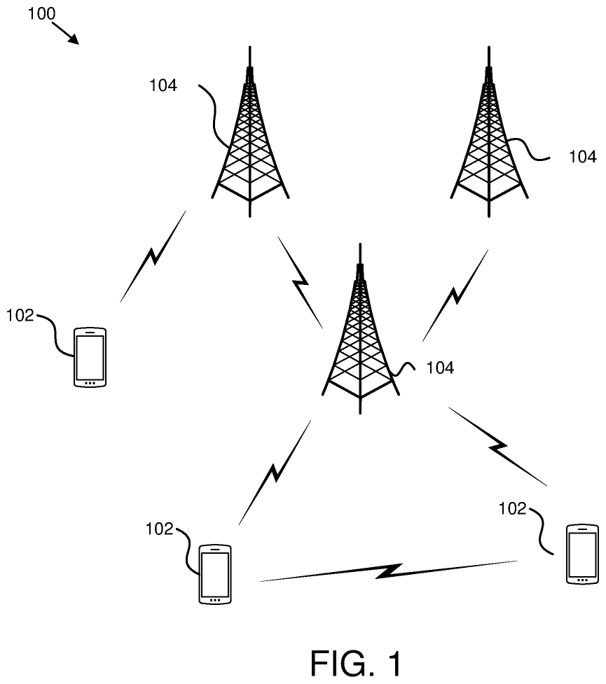

FIG. 1 depicts an embodiment of a wireless communication system 100 for triggering an action in response to an event notification corresponding to a user equipment. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, a middleware entity, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, from a detection entity, an event notification related to an adaption of a behavior of at least one user equipment. In some embodiments, the network unit 104 may determine, in response of receiving the event notification, a trigger action for at least one application of the at least one user equipment. The trigger action includes: an edge support service modification; an edge support service cancellation; an edge support service pause; selection of an alternative application server; creation of a new candidate target application server; or some combination thereof. In certain embodiments, the network unit 104 may transmit the trigger action to an application entity, a further application enablement entity, or a combination thereof to execute the trigger action based on the event notification. Accordingly, the network unit 104 may be used for triggering an action in response to an event notification corresponding to a user equipment.

In certain embodiments, a network unit 104 may receive a monitoring event from an application, a second network entity, or a combination thereof. In some embodiments, the network unit 104 may determine, in response of receiving the monitoring event, an event notification related to an adaption of a behavior of at least one user equipment. In certain embodiments, the network unit 104 may transmit the event notification to a further application enablement entity. Accordingly, the network unit 104 may be used for triggering an action in response to an event notification corresponding to a user equipment.

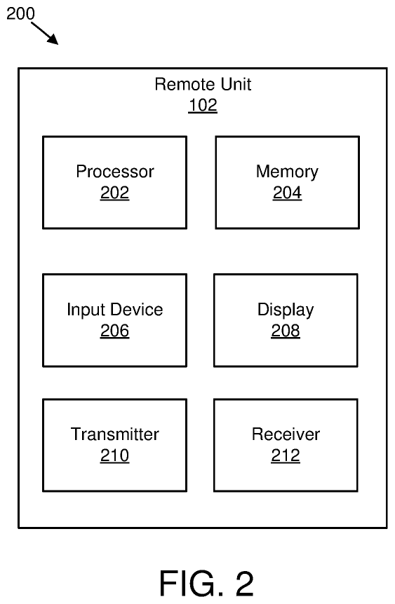

FIG. 2 depicts one embodiment of an apparatus 200 that may be used for triggering an action in response to an event notification corresponding to a user equipment. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the 20) like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

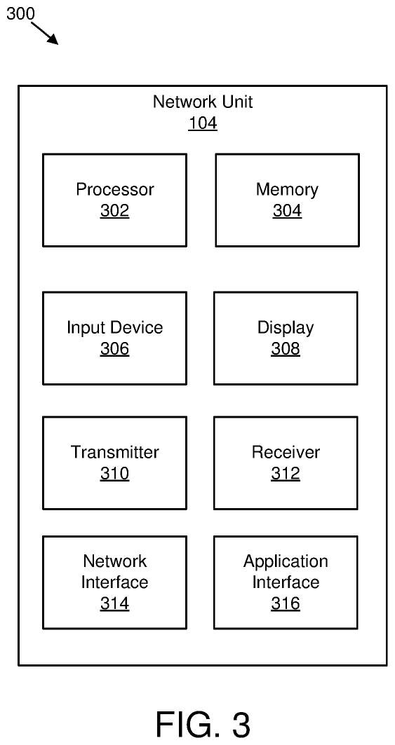

FIG. 3 depicts one embodiment of an apparatus 300 that may be used for triggering an action in response to an event notification corresponding to a user equipment. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively. The apparatus 300 also includes a network interface 314 for communication with network devices and an application interface 316 for communication with applications.

In certain embodiments, the receiver 312 receives, from a detection entity, an event notification related to an adaption of a behavior of at least one user equipment. In various embodiments, the processor 302 determines, in response of receiving the event notification, a trigger action for at least one application of the at least one user equipment. The trigger action includes: an edge support service modification; an edge support service cancellation; an edge support service pause; selection of an alternative application server; creation of a new candidate target application server; or some combination thereof. In certain embodiments, the transmitter 310 transmits the trigger action to an application entity, a further application enablement entity, or a combination thereof to execute the trigger action based on the event notification. As used herein, an edge support service may be an ACR.

In some embodiments, the receiver 312 receives a monitoring event from an application, a second network entity, or a combination thereof. In various embodiments, the processor 302 determines, in response of receiving the monitoring event, an event notification related to an adaption of a behavior of at least one user equipment. In certain embodiments, the transmitter 310 transmits the event notification to a further application enablement entity.

In certain embodiments, a planned user equipment (“UE”) behavior changes after a launch of an edge support service and/or a mobile edge computing (“MEC”) platform service, and the service may need to be changed due to these changes (e.g., due to UE mobility change). As used herein, an edge support service may refer to an edge platform capability (e.g., platform as a service (“PaaS”) and/or software as a service (“SaaS”)) which provides support to application integration and/or enablement with an underlying network. Such support functionality may be an application service continuity support and/or an application context relocation service when a UE migrates to different edge platform or a dynamic application server instantiation.

In some embodiments, such as in mobile edge cloud deployments, one aspect may be portability and/or migration of edge applications to different edge application servers (“EAS”), while maintaining edge service continuity.

In various embodiments, reasons for application client to EAS remapping may be due to: 1) UE mobility-including predictive or expected UE mobility transmitted from an area covered by one EAS to a target area covered by another; 2) overload situations in a source EAS (“S-EAS”) or an edge data network (“EDN”); 3) maintenance aspects (e.g., graceful shutdown of an EAS); 4) an expected performance downgrade at a source EAS; 5) improve a quality of experience for a UE application (e.g., gaming application); and 6) application preference for a different slice and/or data network name (“DNN”).

In some embodiments, if fifth generation (“5G”) is used for communication between edge application servers and clients, such migration to a different EAS may have an impact at a network side for enabling an application context transfer (e.g., transfer of necessary application client context for a target EAS (e.g., application client (“AC”) profile, service key performance indicators (“KPIs”))) with no disruption of a communication service and without affecting the user quality of experience (“QoE”). In such embodiments, the target EAS may be the best candidate based on the application requirements.

In various embodiments, there may be two edge support services for dealing with application portability: application context resolution (“ACR”) service, and dynamic EAS instantiation service.

In certain embodiments, for an ACR service, if a UE moves to a new location, different EASs may be more suitable for serving the UE. Such transitions may result from a non-mobility event requiring support from an edge enabler layer to maintain the continuity of the service. Support for service continuity provides several features for minimizing an application layer service interruption by replacing an S-EAS connected to an AC in the UE, with a target EAS (“T-EAS”). An ACR service may have been specified in an edge enabler layer (“EEL”) which be a middleware layer between a network and edge applications. The S-EAS may be associated with an application context. To support service continuity, an application context from the S-EAS may be transferred to the T-EAS.

In some embodiments, for a dynamic EAS instantiation service, an edge enabler layer may interact with an EAS management system to trigger instantiation of a suitable EAS per application needs (e.g., UE mobility). Upon receiving an EAS discovery request with a EAS discovery filter from an edge enabler client (“EEC”) or a source edge enabler server (“EES”) (S-EES”) during procedures for EAS discovery or ACR, the EES may fail to discover and select the EAS that matches the UE location and the requesting application characteristics due to no EAS being available or instantiated. The EES may trigger the EAS management system to instantiate the EAS serving the AC in the EDN before returning the EAS information to the EEC or the S-EES, based on dynamic EAS instantiation information about which the EAS may be dynamically instantiated at the associated EDN.

In certain embodiments, application mobility service support may be defined and may be part of the edge support service and in particular the service continuity support, for which the service to the user may resume and continue if an application instance is made available in a target MEC host and a user context, if needed, is transferred to the application instance there. In such a service, application mobility enablement and/or registration may be a first step, where this procedure is about enabling the application mobility service and allowing the application instances to register to required application mobility services. This may be followed by application and/or user context transfer initiation, preparation, execution, traffic path update, and clean-up.

In some embodiments, an expected and/or predicted UE mobility may not be accurate and a UE may not be at a predicted location at the given time instance. This can be due to various reasons, such as: 1) traffic congestion which may delay the UE; 2) inaccurate and/or failed prediction (e.g., there may be a confidence level, but it may be wrong); 3) a UE change of behavior, a change in direction, and/or a change in speed); and/or 4) an incident (e.g., an accident, a platform failure) which requires modification of the edge services.

In various embodiments, different scenarios may have the following results: 1) a target UE may not go to a predicted location, so the respective EEL service (e.g., ACR and/or T-EAS instantiation) may need to be cancelled to avoid reserving resources at a T-EAS and/or target EDN; 2) the target UE may go later than predicted to a location, so as ACR and/or T-EAS instantiation may need to be kept even if the UE doesn't show up on time; otherwise, there is a chance that the context may be removed from the T-EAS if not used (e.g., after some time); and/or 3) the target UE may go earlier to the location, so the ACR and/or T-EAS instantiation may need to be completed earlier; otherwise there might be service discontinuity.

Certain embodiments may relate to UE behavior changes that may impact edge enabling services that rely on a predicted UE location and may be related to application portability and/or migration.

In some embodiments, edge application migration may be supported if a UE location and/or mobility deviates from a predicted UE location and/or mobility (e.g., due to prediction failure and/or a change in UE behavior). Such embodiments may include: 1) detecting a UE location deviation and/or mismatch from a predicted UE location (e.g., this may be detected via monitoring the UE location from a 5GC and/or SEAL, or via the AC of the UE), detecting an event captured by a network or an application server, a management triggered event (e.g., performance monitoring (“PM”) and/or fault monitoring (“FM”)), or a network triggered event (e.g., UE changed network slice); 2) evaluating a need for adapting an edge enabling service related to the ACR and/or dynamic EAS instantiation—this may include a cost analysis for maintaining the edge enabling service (e.g., impact on the network and/or platform load)-if there is no impact (e.g., in low load scenarios), there may not be a need to adapt; 3) determining a trigger action—the action may include one or more of the following: a) cancellation of the edge service related to the ACR and/or EAS instantiation; b) pausing of the edge service related to the ACR and/or EAS instantiation for a given time window and/or area of interest; c) modification and/or early completion of the edge service related to the ACR and/or EAS instantiation; d) modification and/or late completion of the edge service related to the ACR and/or EAS instantiation; and/or e) modification and/or change of the target EDN and/or EAS to which the AC is expected to migrate; 4) based on the trigger action type, transmit a trigger event report (e.g., including a proposed and/or suggested action) to the decision entity and the involved entities (e.g., UE, network entities, application entities) to notify, propose, and/or recommend a trigger action-here the decision entity may be the EES and/or EAS of source or target edge platform, or the EEC of the target UE; and/or 5) support the decision entity to apply and/or execute the proposed action.

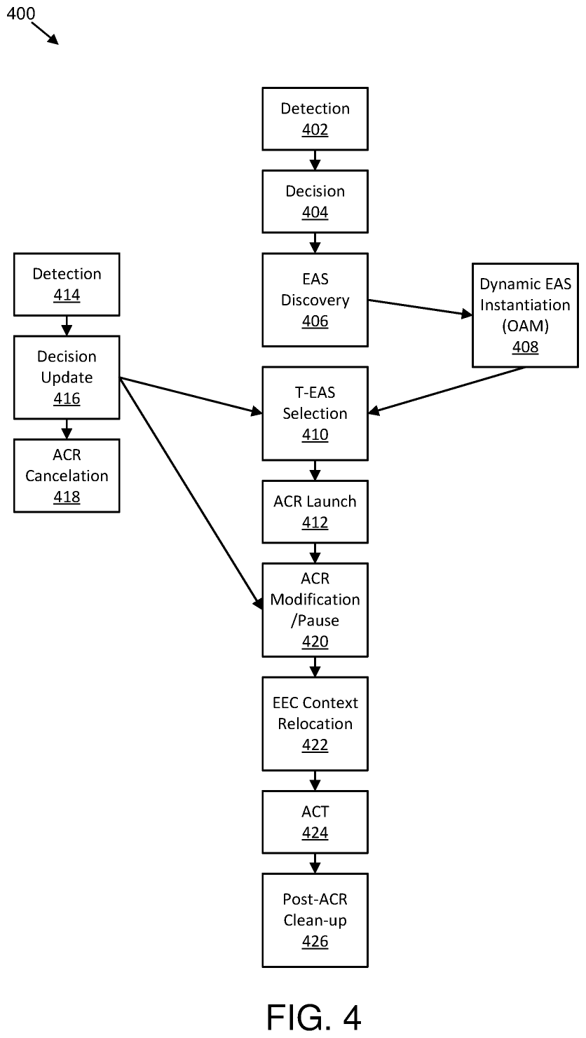

FIG. 4 is a schematic block diagram illustrating one embodiment of a system 400 for triggering an action in response to an event notification corresponding to a user equipment. An entity of the system 400 detects 402 a need for AC to EAS remapping (e.g., this may be an AC and/or EEC or an EES and/or EAS based on a scenario).

Based on the detection, an entity decides 404 the AC to EAS re-mapping (e.g., this entity can be the EES, the EAS, or the EEC). Next, EAS discovery 406 happens (e.g., EEC identifies the available EASs at the target area-dynamic EAS instantiation 408 (e.g., via an OAM)). In particular, in EEC-based (e.g., UE-centric) scenarios, the EEC determines the target (“T”) EES (“T-EES”) by using the provided information or performs a service provisioning procedure. On the other hand, in EES and/or EAS centric scenarios, the S-EES and/or EAS discovers the best T-EES and/or T-EAS.

Step 408 may be done together with the EAS discovery 406. The AC and EEC select 410 the T-EAS to be used for application traffic (or in EES and/or EAS centric scenarios, the determination of the T-EAS happens via source and target EAS and/or EES).

Then ACR launch 412 happens, and this may be done via an ACR request from the EEC (and involves S-EES and/or EAS, ECS, T-EES and/or EAS or a subset of them based on the scenario).

In response to ACR launch 412, there may be detection 414 of an event that is related to a UE change of behavior (e.g., as in step 402), and evaluation of the situation and decision update 416 based on the event. This decision may include one of the following: cancellation, modification, modification with different EAS, and/or pause of the procedure.

Based on the decision update 416, if the decision is for a cancellation, an ACR cancellation 418 message is sent to the decision entity as well as notifications to all involved entities. The ACR stops if an acknowledgement (“ACK”) is received.

If the decision is a pause, an ACR pause 420 message is sent to the decision 404 and execution entity and/or entities (e.g., EES, EAS, EEC, ECS) to notify about the pause decision and the required time for the pause, or under which criteria the ACR will resume (or an ACR resume may follow after some time period if the decision update 416 entity identifies that ACR may continue).

If the decision is a modification, an ACR modification 420 request is sent to the decision 404 and execution entity (or entities) to identify a time offset (e.g., positive or negative based on whether it is to delay or complete earlier). Upon the successful reception of a response, the EEC context relocation 422 happens.

If it is modification with EAS remapping, the entity deciding the T-EAS selection needs to update its mapping, so the ACR modification 420 request includes a flag indicating the requirement of change of T-EAS, or a proposal for an alternative T-EAS.

If the alternative T-EAS is not available at the target EDN area, a dynamic EAS instantiation is triggered by the decision update 416 entity to the OAM (e.g., the service which instantiates the alternative T-EAS).

Following the ACR launch 412 and update, the EEC context relocation 422 happens from the S-EES to the T-EES. It should be noted that the decision update 416 may also happen after the EEC context relocation 422, but before ACT 424. ACT 424 happens between S-EAS and T-EAS. Post-ACR clean-up 426 then happens (e.g., removal of context from S-EES and/or EAS, and notifications).

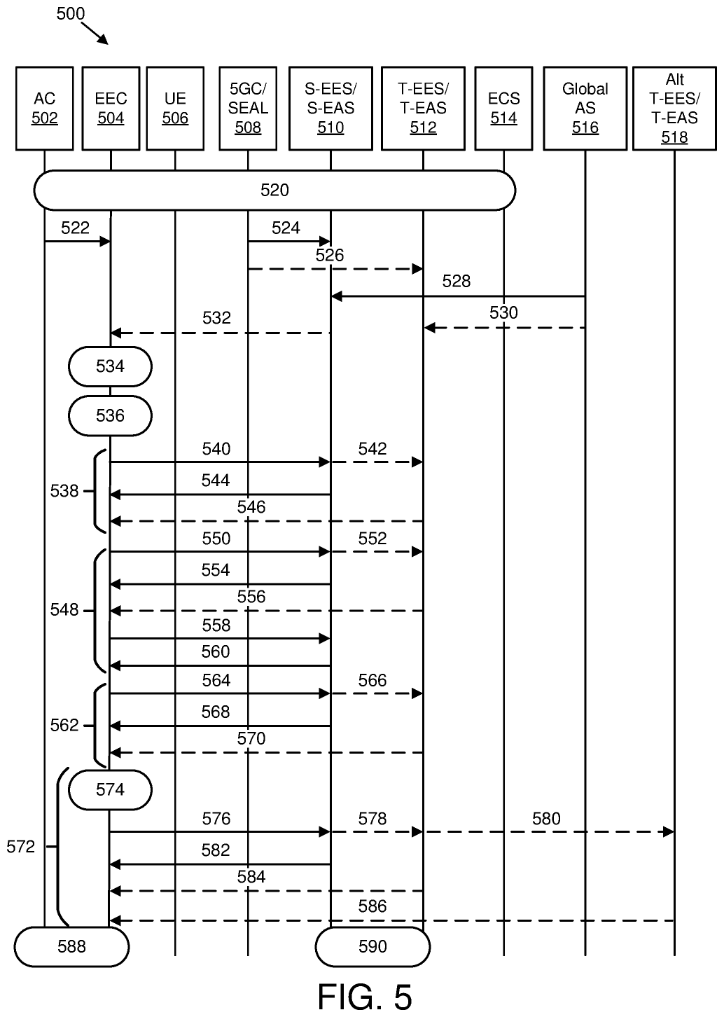

A first embodiment as described herein includes an EEC-based ACR update procedure. This embodiment provides a mechanism for UE and/or EEC triggered ACR update. FIG. 5 is a timing diagram illustrating the first embodiment of a system 500 for triggering an action in response to an event notification corresponding to a user equipment. The system 500 includes an AC 502, an EEC 504, a UE 506 (the AC 502, the EEC 504, and the UE 506 may be part of the same device), a fifth generation core network (“5GC”) 508 (and/or service enabler architecture layer (“SEAL”) location management server (“LMS”)), an S-EES 510 (and/or S-EAS), a T-EES 512 (and/or T-EAS), an ECS 514, a global AS 516, and an alternate (“Alt”) T-EES 518 (and/or T-EAS). It should be noted that each of the illustrated communications may include one or more messages.

In a first communication 520, ACR is launched.

In a second communication 522, the EEC 504 receives from the AC 502 (e.g., over “EDGE-5”) an indication that an expected and/or predicted UE location and/or mobility change. Such message may include a current, new, expected, and/or predicted location (e.g., in coordinates, and/or topological location which may include a cell, an address, and so forth), a current and/or new expected mobility, speed, direction, and/or velocity, and/or an expected change of the UE route and/or trajectory (e.g., update of global positioning system (“GPS”) route).

In a third communication 524 and/or an optional fourth communication 526, S-EES 510 acting as an AF, may receive a UE location report (e.g., based on a subscription to location services) from the 5GC 508. The UE location report may help indicate that the UE 506 is not going to be at the predicted location at the given time, and is expected to deviate by the original location. Also, the S-EES 510 may also receive an application to slice remapping notification from the 5GC 508. This may affect which EAS to attach to. Such notification may include a target single (“S”) network slice selection assistance information (“NSSAI”) (“S-NSSAI”) and/or DNN combination.

In a fifth communication 528 and/or optional sixth communication 530, the global AS 516 may provide a requirement update to the S-EES 510 and optionally to the T-EES 512 indicating an expected change of application behavior, such as a service operation, a profile change, and/or an adaptation of an application attributes that may affect the ACR (e.g., speed of the platoon in vehicle to everything (“V2X”)).

In an optional seventh communication 532, the S-EES 510 sends to the EEC 504 a UE and/or application (“app”) related event report based on steps 524, 526, 528, and/or 530, which provides information about expected UE and/or app behavior changes, and may indicate how this will affect the ACR. One example is that the UE 506 may delay arriving at a target location by X seconds with a given confidence level.

The EEC 504 evaluates 534 the need for adapting the edge enabling service related to the ACR. Then, the EEC 504 determines 536 an action to cancel, pause, modify, and/or change a T-EAS based on the evaluation of step 534.

A first option 538 may include steps 540, 542, 544, and 546. In an eighth communication 540 and/or an optional nineth communication 542, the EEC 504 sends an ACR modification request message. The message may include one or more of the parameters from Table 1. As used in the tables here, “M” indicates mandatory, and “O” indicates optional.

TABLE 1
ACR Modification Request

| Information element | Status | Description |
|---|---|---|
| Requestor identifier | M | Unique identifier of the requestor (e.g., |
| | | EEC ID (“EECID”)). |
| Security credentials | M | Security credentials resulting from a |
| | | successful authorization for the edge |
| | | computing service. |
| UE identifier | O | The identifier of the UE (e.g., generic |
| | | public subscription identifier (“GPSI”)). |
| ACR modification type | M | Indicates the ACR modification type (e.g., |
| flag | | delay or early ACR) |
| ACR session ID | M | Identity of the ACR session that needs to |
| | | be modified |
| New ACT start time | M | New expected start time for ACT start |
| | | based on the modification of the ACR |
| New ACT completion time | O | New expected completion time for ACT |
| | | start based on the modification of the |
| | | ACR |
| New EEC context | O | New expected start time for EEC context |
| relocation start time | | transfer based on the modification of the |
| | | ACR |
| New EEC context | O | New expected completion time for EEC |
| relocation start time | | context transfer based on the modification |
| | | of the ACR |
| T-EAS and/or EES ID and | O | The ID and address of the target EAS |
| address | | and/or EES |
| Target S-NSSAI and/or | O | In case of modification due to slice |
| DNN | | change, the target DNN and/or S-NSSAI |
| | | can be provided at the request |
| Update of the predictive | O | The min-max updated time where an ACR |
| timer and/or time range per | | is expected. This depends on the planning |
| ACR | | on when the UE is expected to move to |
| | | that area, and the range depends on the |
| | | confidence level. The execution entity |
| | | will identify when to start the ACR based |
| | | on the planned ACR request |

In a tenth communication 544 and/or an optional eleventh communication 546, the EEC 504 receives a response to the ACR modification request from the decision and/or execution entity (e.g., one of EES, EAS, edge configuration server (“ECS”)). This ACR modification response message may include one or more elements from Table 2.

TABLE 2

| | | |
|---|---|---|
| Result | M | Indicates whether the request is successful |
| | | or failure |
| Cause information | O | Indicates the cause information for the |
| | | failure of the ACR modification (e.g., |
| | | high load in early ACR case) |
| Negotiated ACR | O | Indicates a possible counter-proposal from |
| modification | | the execution entity, to ensure meeting the |
| | | service continuity requirements |

A second option 548 may include steps 550, 552, 554, 556, 558, and 560. In a twelfth communication 550 and/or an optional thirteenth communication 552, the EEC 504 sends an ACR pause request message. The message may include one or more of the parameters from Table 3.

TABLE 3
ACR Pause Request

| Information element | Status | Description |
|---|---|---|
| Requestor identifier | M | Unique identifier of the requestor (e.g., |
| | | EECID). |
| Security credentials | M | Security credentials resulting from a |
| | | successful authorization for the edge |
| | | computing service. |
| UE identifier | O | The identifier of the UE (e.g., GPSI). |
| ACR session ID | M | Identity of the ACR session that needs to |
| | | be modified |
| Pause configuration | O | Configuration of the pause to indicate |
| | | when to start and/or stop or if an ACR |
| | | resume message is needed to be provided |
| | | to the execution entity |
| ACR Pause time start & | M | New expected start time for ACT start |
| end | | based on the modification of the ACR |
| ACR Pause time duration | M | New expected completion time for ACT |
| | | start based on the modification of the |
| | | ACR |
| Updated ACR and/or ACT | O | The updated time for the completion, |
| completion time | | which will allow the execution entity to |
| | | decide when to pause |
| EEC context relocation | O | New expected start time for EEC context |
| pause start and end time | | transfer based on the modification of the |
| | | ACR |
| T-EAS and/or EES ID and | O | The ID and address of the target EAS |
| address | | and/or EES |
| Update of the predictive | O | The min-max updated time where an ACR |
| timer / time range per ACR | | is expected, based on the pause time. This |
| | | depends on the planning on when the UE |
| | | is expected to move to that area, and the |
| | | range depends on the confidence level. |
| | | The execution entity will identify when to |
| | | start the ACR based on the planned ACR |
| | | request |

In a fourteenth communication 554 and/or an optional fifteenth communication 556, the EEC 504 receives a response from the decision and/or the execution entity (e.g., EES, EAS, ECS) to the ACR pause request. The ACR pause response message may include one or more elements from Table 4.

TABLE 4

| | | |
|---|---|---|
| Result | M | Indicates whether the request is successful |
| | | or failure |
| Cause information | O | Indicates the cause information for the |
| | | failure of the ACR modification (e.g., |
| | | high load in early ACR case) |

In a sixteenth communication 558, the EEC 504 together with AC 502 indicates that the ACR may be resumed after the ACR pause. The ACR resume request message may include one or more elements from Table 5.

TABLE 5

| Information element | Status | Description |
|---|---|---|
| Requestor identifier | M | Unique identifier of the requestor (e.g., |
| | | EECID). |
| Security credentials | M | Security credentials resulting from a |
| | | successful authorization for the edge |
| | | computing service. |
| UE identifier | O | The identifier of the UE (e.g., GPSI). |
| ACR session ID | M | Identity of the ACR session that needs to |
| | | be resumed |
| Updated ACR and/or ACT | O | The updated time for the completion, |
| completion time | | which will allow the execution entity to |
| | | decide when to pause |
| Update of the predictive | O | The min-max updated time where an ACR |
| timer and/or time range per | | is expected, based on the pause time. This |
| ACR | | depends on the planning on when the UE |
| | | is expected to move to that area, and the |
| | | range depends on the confidence level. |
| | | The execution entity will identify when to |
| | | start the ACR based on the planned ACR |
| | | request |

In a seventeenth communication 560, the EEC 504 receives a response from the decision and/or execution entity (e.g., EES, EAS, ECS) to the ACR resume request. The ACR resume response message may include one or more elements from Table 6.

TABLE 6

| | | |
|---|---|---|
| Result | M | Indicates whether the request is successful |
| | | or failure |
| Cause information | O | Indicates the cause information for the |
| | | failure of the ACR resume (e.g., resource |
| | | unavailability, EAS high load) |

A third option 562 may include steps 564, 566, 568, and 570. In an eighteenth communication 564 and/or an optional nineteenth communication 566, the EEC 504 sends an ACR cancellation request message. The message may include one or more of the parameters from Table 7.

TABLE 7
ACR Cancellation Request

| Information element | Status | Description |
|---|---|---|
| Requestor identifier | M | Unique identifier of the requestor (e.g., |
| | | EECID). |
| Security credentials | M | Security credentials resulting from a |
| | | successful authorization for the edge |
| | | computing service. |
| UE identifier | O | The identifier of the UE (e.g., GPSI). |
| ACR session ID | M | Identity of the ACR session that needs to |
| | | be modified |
| Cancellation cause | O | The cause for which the cancellation |
| | | happens (e.g., UE mobility change, slice |
| | | change, EAS failure) |
| EAS notification indication | M | Indicates whether to notify the EAS about |
| | | the cancellation of ACR. |
| S-EAS endpoint | O | Endpoint information of the S-EAS |

In a twentieth communication 568 and/or an optional twenty-first communication 570, the EEC 504 receives a response from the decision and/or execution entity (e.g., EES, EAS, ECS) to the ACR cancellation request. The ACR cancellation response message may include one or more of the elements of Table 8.

TABLE 8

| | | |
|---|---|---|
| Result | M | Indicates whether the request is successful |
| | | or failure |

A fourth option 572 may include steps 574, 576, 578, 580, 582, 584, and 586. The AC 502 and the EEC 504 select 574 a new T-EAS to be used for the application traffic (e.g., based on the ACR adaptation trigger to change the target EAS), and optionally a new T-EES (e.g., alt T-EES 518) corresponding to the new T-EAS. Such T-EES 518 may be at the same or different EDN.

In a twenty-second communication 576, an optional twenty-third communication 578, and/or an optional twenty-fourth communication 580, the EEC 504 sends an EAS and/or EES modification request message to one or more of the execution entities (e.g., EES, EAS, ECS). The message may include one or more of the parameters in Table 9.

TABLE 9
EES and/or EAS Modification Request

| Information element | Status | Description |
|---|---|---|
| Requestor identifier | M | Unique identifier of the requestor (e.g., |
| | | EECID). |
| Security credentials | M | Security credentials resulting from a |
| | | successful authorization for the edge |
| | | computing service. |
| UE identifier | O | The identifier of the UE (e.g., GPSI). |
| ACR modification type | M | Indicates the ACR modification type |
| flag | | (change of EES or EAS or both) |
| ACR session ID | M | Identity of the ACR session that needs to |
| | | be modified |
| Modification data | M | Indicates the modification data for the |
| | | EES and/or EAS |
| New T-EAS Endpoint | M | Endpoint information (e.g., uniform |
| | | resource identifier (“URI”), fully qualified |
| | | domain name (“FQDN”), internet protocol |
| | | (“IP”) 3-tuple) of the T-EAS. |
| List of data network access | O | DNAI information associated with the |
| identifier (“DNAIs”) of | | new T-EAS. |
| new T-EAS | | |
| N6 Traffic Routing | O | The N6 traffic routing information and/or |
| requirements | | routing profile ID corresponding to the T- |
| | | EAS DNAIs. |
| EAS notification indication | M | Indicates whether to notify the old T-EAS |
| | | or S-EAS about the modification |
| S-EAS endpoint | O | Endpoint information of the S-EAS |
| Old T-EAS endpoint | | Endpoint information of the old T-EAS |
| New T-EES Endpoint | O | Endpoint information (e.g., URI, FQDN, |
| | | IP 3-tuple) of the T-EES. |
| S-EAS endpoint | O | Endpoint information of the S-EAS |
| Old T-EAS endpoint | | Endpoint information of the old T-EAS |
| Target S-NSSAI and/or | O | In case of modification due to slice |
| DNN | | change, the target DNN and/or S-NSSAI |
| | | can be provided at the request |
| Update of the Predictive | O | The min-max updated time where an ACR |
| timer and/or time range per | | is expected. This depends on the planning |
| ACR | | on when the UE is expected to move to |
| | | that area, and the range depends on the |
| | | confidence level. The execution entity |
| | | will identify when to start the ACR based |
| | | on the planned ACR request |

In a twenty-fifth communication 582, an optional twenty-sixth communication 584, and/or an optional twenty-seventh communication 586, the EEC 504 receives a response from the decision and/or execution entity (e.g., EES, EAS, ECS) to the EES and/or EAS modification request. The EES and/or EAS modification response message may include one or more elements from Table 10.

TABLE 10

| | | |
|---|---|---|
| Result | M | Indicates whether the request is successful |
| | | or failure |
| Cause information | O | Indicates the cause information for the |
| | | failure of the EES and/or EAS |
| | | modification (e.g., unavailability of EAS |
| | | and/or EES) |
| Negotiated EES and/or | O | Indicates a possible counter-proposal from |
| EAS modification | | the execution entity, to ensure meeting the |
| | | service continuity requirements |

In some embodiments, in a twenty-eighth communication 588, the EEC 504 notifies the AC 502 about the result of the ACR modification, cancellation, and/or EES-EAS change.

In a twenty-nineth communication 590, the S-EES 510 and/or the T-EES 512 notifies the S-EAS and/or T-EAS about the result of the ACR modification, cancellation, and/or EES-EAS change.

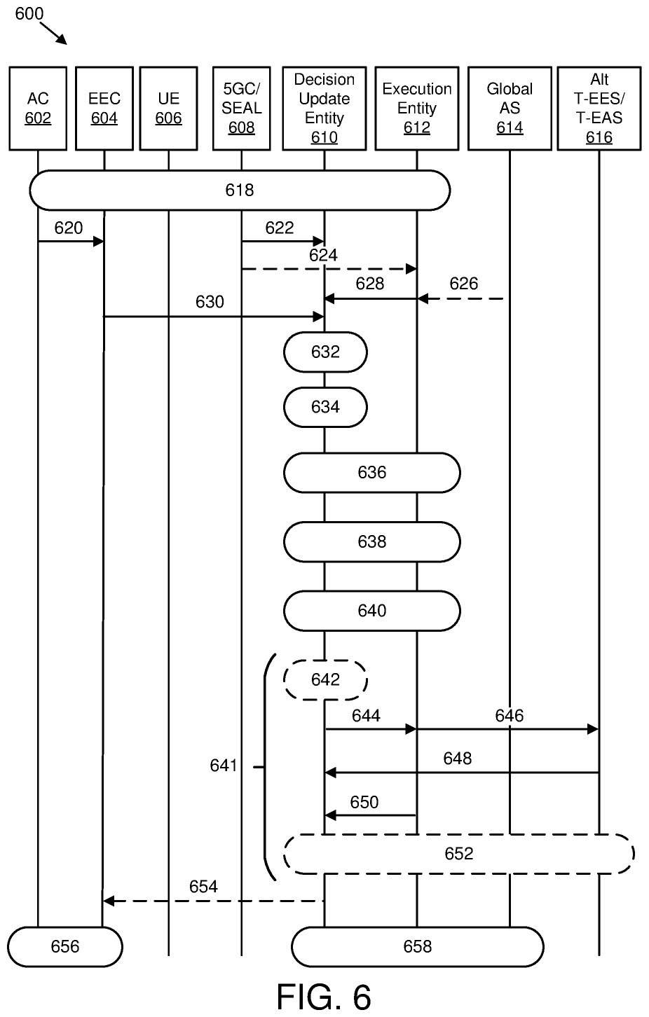

A second embodiment as described herein includes an EES and/or EAS-based ACR update procedure. This procedure may include an implementation of an EAS and/or EES triggered change. FIG. 6 is a timing diagram illustrating the second embodiment of a system 600 for triggering an action in response to an event notification corresponding to a user equipment. The system 600 includes an AC 602, an EEC 604, a UE 606 (the AC 602, the EEC 604, and the UE 606 may be part of the same device), a 5GC 608 (and/or SEAL LMS), a decision update entity 610, an execution entity 612, a global AS 614, and an alternate (“Alt”) T-EES 616 (and/or T-EAS). It should be noted that each of the illustrated communications may include one or more messages.

In a first communication 618, ACR is launched.

In a second communication 620, the EEC 604 receives from the AC 602 (e.g., over EDGE-5) an indication that an expected and/or predicted UE location and/or mobility change. Such message may include a current, new, expected, and/or predicted location (e.g., in coordinates, and/or topological location which may include a cell, an address, and so forth), a current and/or new expected mobility, speed, direction, and/or velocity, and/or an expected change of the UE route and/or trajectory (e.g., update of GPS route).

In a third communication 622 and/or an optional fourth communication 624, the decision update entity 610 (e.g., S-EES, S-EAS, T-EES based on the scenario) acting as AF, may receive a UE location report (e.g., based on subscription to location services) from 5GC 608. The UE location report may help indicate that the UE 606 is not going to be at the predicted location at the given time, and is expected to deviate by the original location. Also, the decision update entity 610 may also receive an application to slice remapping notification from the 5GC 608. This may affect which EAS to attach to. Such notification may include a target S-NSSAI and/or DNN combination.

In an optional fifth communication 626 and/or a sixth communication 628, the global AS 614 may provide a requirement update to the decision update entity 610 indicating an expected change of the application behavior, such as service operation, profile change, and/or adaptation of an application attribute that may affect the ACR (e.g., speed of the platoon in V2X).

In a seventh communication 630, the decision update entity 610 receives from a predicted UE location report derived by the AC 602 at step 620.

The decision update entity 610 evaluates 632 the need for adapting the edge enabling service related to the ACR.

The decision update entity 610 determines 634 an action to cancel, pause, modify, and/or change T-EAS based on the evaluation of step 632.

In a first option that includes an eighth communication 636, the decision update entity 610 sends an ACR modification request and/or indication message (e.g., between the decision update entity 610 and the execution entity 612 (or entities). The message may be similar to the first option 538 of the first embodiment, however, one difference may be that a requestor ID may be the EES identifier (“ID”) (“EESID”) or EAS ID (“EASID”) and the message may include EAS profile information for one or both of a source EAS and a target EAS. Also, the message may be an indication for some recipients (e.g., rather than a request). The decision update entity 610 receives a response to the ACR modification request from the execution entity 612. This ACR modification response message may be the same as for the first option 538 of the first embodiment.

In a second option that includes a nineth communication 638, the decision update entity 610 sends an ACR pause request and/or indication message. The message may be similar to the second option 548 of the first embodiment; however, one difference may be that the requestor ID may be the EESID or EASID and the message may also include the EAS profile information for one or both of a source EAS and a target EAS. Also, the message may be an indication for some recipients (e.g., rather than a request). The decision update entity 610 receives a response to the ACR pause request from the execution entity 612 (e.g., EES, EAS, ECS). The ACR pause response message may be the same as that of the second option 548 of the first embodiment. The decision update entity 610 indicates that the ACR may be resumed after the ACR Pause. The message may be similar to the second option 548 of the first embodiment; however, one difference may be that the requestor ID may be the EESID or EASID and the message may also include the EAS profile information for one or both of a source EAS and a target EAS. Also, it may include an indication for some recipients (e.g., rather than a request). The decision update entity 610 receives a response to the ACR resume request from the execution entity 612 (e.g., EES, EAS, ECS). This ACR resume response message may be the same as that of the second option 548 of the first embodiment.

In a third option that includes a tenth communication 640, the decision update entity 610 sends an ACR cancellation request message to the execution entity 612 (e.g., or execution entities) and receives an ACR cancellation response. The messages may be similar to that of the third option 562 of the first embodiment. Also, it may include an indication for some recipients (e.g., rather than a request).

A fourth option 641 may include steps 642, 644, 646, 648, 650, and 652. The 20) decision update entity 610 may select 642 a new T-EAS to be used for the application traffic (e.g., based on the ACR adaptation trigger to change the target EAS), and optionally the alternate T-EES 616 corresponding to the new T-EAS. The T-EES 616 may be at a same or different EDN.

In an eleventh communication 644 and/or a twelfth communication 646, the decision update entity 610 sends an EAS and/or EES modification request message to the execution entity 612 (e.g., one or more of EES, EAS, and ECS) and optionally to an EEC and/or 25 AC. Following this, in a thirteenth communication 648 and/or a fourteenth communication 650, the decision update entity 610 receives a response to the EES and/or EAS modification request from the decision and/or execution entity 612. These messages may be similar to the messages of the fourth option 572 of the first embodiment, with possible addition of the requestor ID which may be the EESID or EASID and the message may also include the EAS profile information for one or both of a source EAS and a target EAS. Also, it may include an indication for some recipients (e.g., rather than a request). In an optional fifteenth communication 652, one or more T-EAS reselection complete messages may be sent.

In an optional sixteenth communication 654, the decision update entity 610 sends a notification message to the AC 602 via the EEC 604 (or directly) about the decision on the ACR modification, cancellation, and/or EES-EAS change. This notification message may include: an ACR ID; a session ID; a type of ACR update; if it is a pause—the time for which the pause is expected; if it is a change of T-EAS—the ID, endpoint, and/or address of T-EAS; and/or if it is a newly instantiated T-EAS, the authorization information capabilities, and ID and/or address of the new EAS.

In an optional seventeenth communication 656, the EEC 604 may also notify the AC 602 of the update. In an eighteenth communication 658, the decision update entity 610 notifies the S-EAS and/or the T-EAS about the result of the ACR modification, cancellation, and/or EES-EAS change.

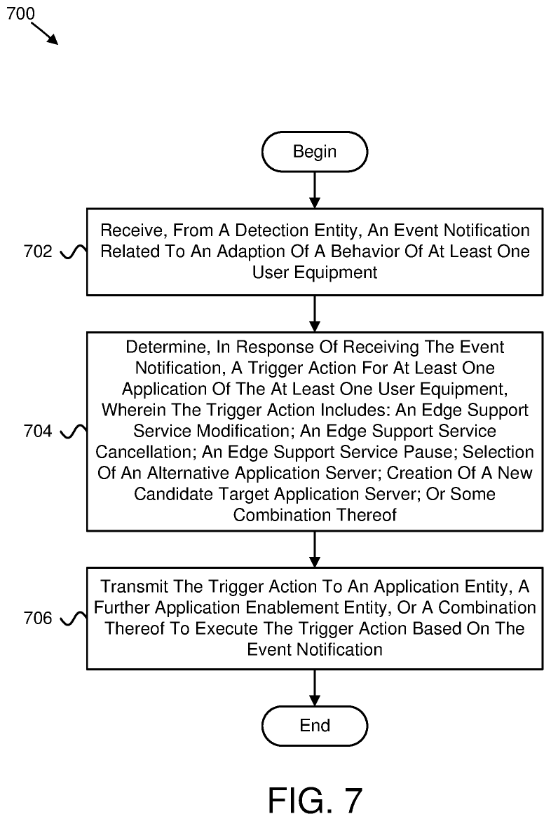

FIG. 7 is a flow chart diagram illustrating one embodiment of a method 700 for triggering an action in response to an event notification corresponding to a user equipment. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, from a detection entity, an event notification related to an adaption of a behavior of at least one user equipment. In some embodiments, the method 700 includes determining 704, in response of receiving the event notification, a trigger action for at least one application of the at least one user equipment. The trigger action includes: an edge support service modification; an edge support service cancellation; an edge support service pause; selection of an alternative application server; creation of a new candidate target application server; or some combination thereof. In certain embodiments, the method 700 includes transmitting 706 the trigger action to an application entity, a further application enablement entity, or a combination thereof to execute the trigger action based on the event notification.

In certain embodiments, the event notification comprises at least one parameter that is expected to change, and the at least one parameter comprises: an expected mobility of the at least one user equipment; a predicted mobility of the at least one user equipment; an expected location of the at least one user equipment; a predicted location of the at least one user equipment; an expected change of speed of the at least one user equipment; a predicted change of speed of the at least one user equipment; an expected direction of the at least one user equipment; a predicted direction of the at least one user equipment; a change of a service profile of the at least one application of the at least one user equipment; a change of a service operation of the at least one application of the at least one user equipment; a confidence level of a predicted user equipment behavior; an expected quality of service of the at least one user equipment; an expected quality of service of a network device; a predicted quality of service of the at least one user equipment; a predicted quality of service of the network device; or some combination thereof.

In some embodiments, the event notification further comprises: a network failure, a network interface failure, an application interface failure, an edge data network unavailability indication, an edge data network failure indication, or some combination thereof. In various embodiments, the edge support service modification comprises a request to an application entity, wherein the request comprises: an application identifier; a user equipment identifier; an edge support service modification type flag; an edge support service session identifier; an application context transfer start time; an application context transfer completion time; an edge enabler client context relocation start time; an edge enabler client context relocation completion time; a target edge application server identifier; a target edge application server address; an edge enabler server identifier; an edge enabler server address; a target single network slice selection assistance information; a target data network name; an update of a predictive timer per event notification; an update of a time range per event notification; or some combination thereof.

In one embodiment, the edge support service pause comprises a request to the application entity comprising: an application identifier; a user equipment identifier; an edge support service session identifier; an event notification pause time start; an event notification pause end time; an event notification pause time duration; an event notification completion time; an application context transfer completion time; an edge enabler client context relocation pause start time; an edge enabler client context relocation end time; a target edge application server identifier; a target edge application server address; an edge enabler server identifier; an edge enabler server address; an update of a predictive timer per event notification; an update of a time range per event notification; or some combination thereof. In certain embodiments, the method 700 further comprises transmitting an event notification resume trigger action to notify the application entity that the event notification is required to resume.

In some embodiments, the network entity comprises an application enablement entity. In various embodiments, the application enablement entity comprises an edge enabler client or an edge enabler server. In one embodiment, the application enablement entity is configured to control an edge application service continuity for the at least one application.

In certain embodiments, the method 700 further comprises transmitting the trigger action to the application entity, the further application enablement entity, or the combination thereof to execute the trigger action based on the event notification. In some embodiments, the method 700 further comprises translating the trigger action to at least one edge service parameter for an application service of the at least one application of the at least one user equipment.

In various embodiments, the method 700 further comprises determining, based on the trigger action, an update to edge enabler client context relocation parameters, an application context corresponding to the edge enabler client context relocation parameters, or a combination thereof. In one embodiment, the method 700 further comprises triggering, based on the trigger action, a dynamic edge application server instantiation, a pro-active edge application server instantiation, or a combination thereof.

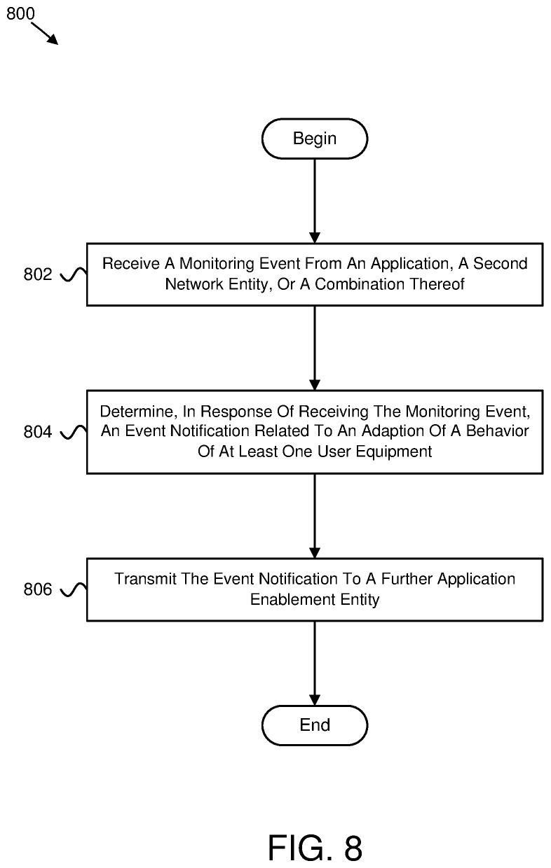

FIG. 8 is a flow chart diagram illustrating another embodiment of a method 800 for triggering an action in response to an event notification corresponding to a user equipment. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802 a monitoring event from an application, a second network entity, or a combination thereof. In some embodiments, the method 800 includes determining 804, in response of receiving the monitoring event, an event notification related to an adaption of a behavior of at least one user equipment. In certain embodiments, the method 800 includes transmitting 806 the event notification to a further application enablement entity.

In certain embodiments, the network entity comprises an application enablement entity. In some embodiments, the application enablement entity comprises an application client, an edge enabler client, an edge enabler server, or an edge configuration server.

In various embodiments, the application enablement entity is configured to detect a change of user equipment behavior. In one embodiment, the monitoring event comprises a change of a user equipment mobility, a change in a user equipment location, a change in application behavior, a change of network conditions at a target edge service area, a network failure at a target area, or some combination thereof.

In one embodiment, an apparatus comprises a network entity. The apparatus further comprises: a receiver that receives, from a detection entity, an event notification related to an adaption of a behavior of at least one user equipment; a processor that determines, in response of receiving the event notification, a trigger action for at least one application of the at least one user equipment, wherein the trigger action comprises: an edge support service modification; an edge support service cancellation; an edge support service pause; selection of an alternative application server; creation of a new candidate target application server; or some combination thereof; and a transmitter that transmits the trigger action to an application entity, a further application enablement entity, or a combination thereof to execute the trigger action based on the event notification.

In certain embodiments, the event notification comprises at least one parameter that is expected to change, and the at least one parameter comprises: an expected mobility of the at least one user equipment; a predicted mobility of the at least one user equipment; an expected location of the at least one user equipment; a predicted location of the at least one user equipment; an expected change of speed of the at least one user equipment; a predicted change of speed of the at least one user equipment; an expected direction of the at least one user equipment; a predicted direction of the at least one user equipment; a change of a service profile of the at least one application of the at least one user equipment; a change of a service operation of the at least one application of the at least one user equipment; a confidence level of a predicted user equipment behavior; an expected quality of service of the at least one user equipment; an expected quality of service of a network device; a predicted quality of service of the at least one user equipment; a predicted quality of service of the network device; or some combination thereof.

In some embodiments, the event notification further comprises: a network failure, a network interface failure, an application interface failure, an edge data network unavailability indication, an edge data network failure indication, or some combination thereof.

In various embodiments, the edge support service modification comprises a request to an application entity, wherein the request comprises: an application identifier; a user equipment identifier; an edge support service modification type flag; an edge support service session identifier; an application context transfer start time; an application context transfer completion time; an edge enabler client context relocation start time; an edge enabler client context relocation completion time; a target edge application server identifier; a target edge application server address; an edge enabler server identifier; an edge enabler server address; a target single network slice selection assistance information; a target data network name; an update of a predictive timer per event notification; an update of a time range per event notification; or some combination thereof.

In one embodiment, the edge support service pause comprises a request to the application entity comprising: an application identifier; a user equipment identifier; an edge support service session identifier; an event notification pause time start; an event notification pause end time; an event notification pause time duration; an event notification completion time; an application context transfer completion time; an edge enabler client context relocation pause start time; an edge enabler client context relocation end time; a target edge application server identifier; a target edge application server address; an edge enabler server identifier; an edge enabler server address; an update of a predictive timer per event notification; an update of a time range per event notification; or some combination thereof.

In certain embodiments, the transmitter transmits an event notification resume trigger action to notify the application entity that the event notification is required to resume.

In some embodiments, the network entity comprises an application enablement entity.

In various embodiments, the application enablement entity comprises an edge enabler client or an edge enabler server.

In one embodiment, the application enablement entity is configured to control an edge application service continuity for the at least one application.

In certain embodiments, transmitter transmits the trigger action to the application entity, the further application enablement entity, or the combination thereof to execute the trigger action based on the event notification.

In some embodiments, the processor translates the trigger action to at least one edge service parameter for an application service of the at least one application of the at least one user equipment.

In various embodiments, the processor determines, based on the trigger action, an update to edge enabler client context relocation parameters, an application context corresponding to the edge enabler client context relocation parameters, or a combination thereof.

In one embodiment, the processor triggers, based on the trigger action, a dynamic edge application server instantiation, a pro-active edge application server instantiation, or a combination thereof.

In one embodiment, a method of a network entity comprises: receiving, from a detection entity, an event notification related to an adaption of a behavior of at least one user equipment; determining, in response of receiving the event notification, a trigger action for at least one application of the at least one user equipment, wherein the trigger action comprises: an edge support service modification; an edge support service cancellation; an edge support service pause; selection of an alternative application server; creation of a new candidate target application server; or some combination thereof; and transmitting the trigger action to an application entity, a further application enablement entity, or a combination thereof to execute the trigger action based on the event notification.

In certain embodiments, the event notification comprises at least one parameter that is expected to change, and the at least one parameter comprises: an expected mobility of the at least one user equipment; a predicted mobility of the at least one user equipment; an expected location of the at least one user equipment; a predicted location of the at least one user equipment; an expected change of speed of the at least one user equipment; a predicted change of speed of the at least one user equipment; an expected direction of the at least one user equipment; a predicted direction of the at least one user equipment; a change of a service profile of the at least one application of the at least one user equipment; a change of a service operation of the at least one application of the at least one user equipment; a confidence level of a predicted user equipment behavior; an expected quality of service of the at least one user equipment; an expected quality of service of a network device; a predicted quality of service of the at least one user equipment; a predicted quality of service of the network device; or some combination thereof.

In some embodiments, the event notification further comprises: a network failure, a network interface failure, an application interface failure, an edge data network unavailability indication, an edge data network failure indication, or some combination thereof.

In various embodiments, the edge support service modification comprises a request to an application entity, wherein the request comprises: an application identifier; a user equipment identifier; an edge support service modification type flag; an edge support service session identifier; an application context transfer start time; an application context transfer completion time; an edge enabler client context relocation start time; an edge enabler client context relocation completion time; a target edge application server identifier; a target edge application server address; an edge enabler server identifier; an edge enabler server address; a target single network slice selection assistance information; a target data network name; an update of a predictive timer per event notification; an update of a time range per event notification; or some combination thereof.

In one embodiment, the edge support service pause comprises a request to the application entity comprising: an application identifier; a user equipment identifier; an edge support service session identifier; an event notification pause time start; an event notification pause end time; an event notification pause time duration; an event notification completion time; an application context transfer completion time; an edge enabler client context relocation pause start time; an edge enabler client context relocation end time; a target edge application server identifier; a target edge application server address; an edge enabler server identifier; an edge enabler server address; an update of a predictive timer per event notification; an update of a time range per event notification; or some combination thereof.

In certain embodiments, the method further comprises transmitting an event notification resume trigger action to notify the application entity that the event notification is required to resume.

In some embodiments, the network entity comprises an application enablement entity.

In various embodiments, the application enablement entity comprises an edge enabler client or an edge enabler server.

In one embodiment, the application enablement entity is configured to control an edge application service continuity for the at least one application.

In certain embodiments, the method further comprises transmitting the trigger action to the application entity, the further application enablement entity, or the combination thereof to execute the trigger action based on the event notification.

In some embodiments, the method further comprises translating the trigger action to at least one edge service parameter for an application service of the at least one application of the at least one user equipment.

In various embodiments, the method further comprises determining, based on the trigger action, an update to edge enabler client context relocation parameters, an application context corresponding to the edge enabler client context relocation parameters, or a combination thereof.

In one embodiment, the method further comprises triggering, based on the trigger action, a dynamic edge application server instantiation, a pro-active edge application server instantiation, or a combination thereof.

In one embodiment, an apparatus comprises a first network entity. The apparatus further comprises: a receiver that receives a monitoring event from an application, a second network entity, or a combination thereof; a processor that determines, in response of receiving the monitoring event, an event notification related to an adaption of a behavior of at least one user equipment; and a transmitter that transmits the event notification to a further application enablement entity.

In certain embodiments, the network entity comprises an application enablement entity.

In some embodiments, the application enablement entity comprises an application client, an edge enabler client, an edge enabler server, or an edge configuration server.

In various embodiments, the application enablement entity is configured to detect a change of user equipment behavior.

In one embodiment, the monitoring event comprises a change of a user equipment mobility, a change in a user equipment location, a change in application behavior, a change of network conditions at a target edge service area, a network failure at a target area, or some combination thereof.

In one embodiment, a method of a first network entity comprises: receiving a monitoring event from an application, a second network entity, or a combination thereof; determining, in response of receiving the monitoring event, an event notification related to an adaption of a behavior of at least one user equipment; and transmitting the event notification to a further application enablement entity.

In certain embodiments, the network entity comprises an application enablement entity.

In some embodiments, the application enablement entity comprises an application client, an edge enabler client, an edge enabler server, or an edge configuration server.

In various embodiments, the application enablement entity is configured to detect a change of user equipment behavior.

In one embodiment, the monitoring event comprises a change of a user equipment mobility, a change in a user equipment location, a change in application behavior, a change of network conditions at a target edge service area, a network failure at a target area, or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a network function, the apparatus comprising:
at least one memory; and
at least one processor coupled with the at least one memory and configured to cause the apparatus to:
receive, from a detection entity, an event notification related to an adaption of a behavior of at least one user equipment (UE);
determine, in response of receiving the event notification, a trigger action for at least one application of the at least one UE, wherein the trigger action comprises:
an edge support service modification;
an edge support service cancellation;
an edge support service pause;
selection of an alternative application server;
creation of a new candidate target application server; or
a combination thereof; and
transmit the trigger action to an application entity, a further application enablement entity, or a combination thereof to execute the trigger action based on the event notification.

2. The apparatus of claim 1, wherein the event notification comprises at least one parameter that is expected to change, and the at least one parameter comprises:
an expected mobility of the at least one UE;
a predicted mobility of the at least one UE;
an expected location of the at least one UE;
a predicted location of the at least one UE;
an expected change of speed of the at least one UE;
a predicted change of speed of the at least one UE;
an expected direction of the at least one UE;
a predicted direction of the at least one UE;
a change of a service profile of the at least one application of the at least one UE;
a change of a service operation of the at least one application of the at least one UE;
a confidence level of a predicted UE behavior;
an expected quality of service of the at least one UE;
an expected quality of service of a network device;
a predicted quality of service of the at least one UE;
a predicted quality of service of the network device;
or a combination thereof.

3. The apparatus of claim 1, wherein the event notification further comprises: a network failure, a network interface failure, an application interface failure, an edge data network unavailability indication, an edge data network failure indication, or a combination thereof.

4. The apparatus of claim 1, wherein the edge support service modification comprises a request to an application entity, wherein the request comprises:
an application identifier;
a UE identifier;
an edge support service modification type flag;
an edge support service session identifier;
an application context transfer start time;
an application context transfer completion time;
an edge enabler client context relocation start time;
an edge enabler client context relocation completion time;
a target edge application server identifier;
a target edge application server address;
an edge enabler server identifier;
an edge enabler server address;
a target single network slice selection assistance information;
a target data network name;
an update of a predictive timer per event notification;
an update of a time range per event notification;
or a combination thereof.

5. The apparatus of claim 1, wherein the edge support service pause comprises a request to the application entity comprising:
an application identifier;
a UE identifier;
an edge support service session identifier;
an event notification pause time start;
an event notification pause end time;
an event notification pause time duration;
an event notification completion time;
an application context transfer completion time;
an edge enabler client context relocation pause start time;
an edge enabler client context relocation end time;
a target edge application server identifier;
a target edge application server address;
an edge enabler server identifier;
an edge enabler server address;
an update of a predictive timer per event notification;
an update of a time range per event notification;
or a combination thereof.

6. The apparatus of claim 5, wherein the at least one processor is configured to cause the apparatus to transmit an event notification resume trigger action to notify the application entity that the event notification is required to resume.

7. The apparatus of claim 1, wherein the network function comprises an application enablement entity.

8. The apparatus of claim 7, wherein the application enablement entity comprises an edge enabler client or an edge enabler server.

9. The apparatus of claim 7, wherein the application enablement entity is configured to control an edge application service continuity for the at least one application.

10. The apparatus of claim 1, wherein the at least one processor is configured to cause the apparatus to transmit the trigger action to the application entity, the further application enablement entity, or the combination thereof to execute the trigger action based on the event notification.

11. The apparatus of claim 1, wherein the at least one processor is configured to cause the apparatus to translate the trigger action to at least one edge service parameter for an application service of the at least one application of the at least one UE.

12. The apparatus of claim 1, wherein the at least one processor is configured to cause the apparatus to determine, based on the trigger action, an update to edge enabler client context relocation parameters, an application context corresponding to the edge enabler client context relocation parameters, or a combination thereof.

13. The apparatus of claim 1, wherein the at least one processor is configured to cause the apparatus to trigger, based on the trigger action, a dynamic edge application server instantiation, a pro-active edge application server instantiation, or a combination thereof.

14. A method of performing a network function, the method comprising:
receiving, from a detection entity, an event notification related to an adaption of a behavior of at least one user equipment (UE);
determining, in response of receiving the event notification, a trigger action for at least one application of the at least one UE, wherein the trigger action comprises:
an edge support service modification;
an edge support service cancellation;
an edge support service pause;
selection of an alternative application server;
creation of a new candidate target application server; or
a combination thereof; and
transmitting the trigger action to an application entity, a further application enablement entity, or a combination thereof to execute the trigger action based on the event notification.

15. An apparatus for performing a network function, the apparatus comprising:
at least one memory; and
at least one processor coupled with the at least one memory and configured to cause the apparatus to:
receive a monitoring event from an application, a second network entity, or a combination thereof;
determine, in response of receiving the monitoring event, an event notification related to an adaption of a behavior of at least one user equipment (UE); and
transmit the event notification to a further application enablement entity.

16. A method of performing a network function, the method comprising:
receiving a monitoring event from an application, a second network entity, or a combination thereof;
determining, in response of receiving the monitoring event, an event notification related to an adaption of a behavior of at least one user equipment (UE); and
transmitting the event notification to a further application enablement entity.

17. The method of claim 14, wherein the event notification comprises at least one parameter that is expected to change, and the at least one parameter comprises:
an expected mobility of the at least one UE;
a predicted mobility of the at least one UE;
an expected location of the at least one UE;
a predicted location of the at least one UE;
an expected change of speed of the at least one UE;
a predicted change of speed of the at least one UE;
an expected direction of the at least one UE;
a predicted direction of the at least one UE;
a change of a service profile of the at least one application of the at least one UE;
a change of a service operation of the at least one application of the at least one UE;
a confidence level of a predicted UE behavior;
an expected quality of service of the at least one UE;
an expected quality of service of a network device;
a predicted quality of service of the at least one UE;
a predicted quality of service of the network device;
or a combination thereof.

18. The method of claim 14, wherein the event notification further comprises: a network failure, a network interface failure, an application interface failure, an edge data network unavailability indication, an edge data network failure indication, or a combination thereof.

19. The method of claim 14, wherein the edge support service modification comprises a request to an application entity, wherein the request comprises:
an application identifier;
a UE identifier;
an edge support service modification type flag;
an edge support service session identifier;
an application context transfer start time;
an application context transfer completion time;
an edge enabler client context relocation start time;
an edge enabler client context relocation completion time;
a target edge application server identifier;
a target edge application server address;
an edge enabler server identifier;
an edge enabler server address;
a target single network slice selection assistance information;
a target data network name;
an update of a predictive timer per event notification;
an update of a time range per event notification;
or a combination thereof.

20. The method of claim 14, wherein the edge support service pause comprises a request to the application entity comprising:
an application identifier;
a UE identifier;
an edge support service session identifier;
an event notification pause time start;
an event notification pause end time;
an event notification pause time duration;
an event notification completion time;
an application context transfer completion time;
an edge enabler client context relocation pause start time;
an edge enabler client context relocation end time;
a target edge application server identifier;
a target edge application server address;
an edge enabler server identifier;
an edge enabler server address;
an update of a predictive timer per event notification;
an update of a time range per event notification;
or a combination thereof.
